(19) United States
(12) Patent Application Publication
(10) Pub. No.: US 2008/0059324 A1
(43) Pub. Date: Mar. 6, 2008

(54) Method for providing customized facial tissue to consumers

(76) Inventors: Andrew Peter Bakken, Appleton, WI (US); Mike Thomas Goulet, Neenah, WI (US); Jeffrey Dean Lindsay, Appleton, WI (US); Thomas Gerard Shannon, Neenah, WI (US); Benjamin Peter Sierra, Appleton, WI (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/514,011

(22) Filed: Aug. 31, 2006

(51) Int. Cl. G06Q 30/00

(52) U.S. Cl. 705/26

(57) ABSTRACT

Facial tissue products can be customized by providing readers or customers of topical mediums, such as topical magazines or websites, with related graphics and tissue basesheet options through an advertisement in the magazine or website that directs the reader to a website. Through the website, the reader can select and order their customized products, which can be shipped directly to the reader.

### BACKGROUND OF THE INVENTION

Facial tissues are commercially marketed by tissue manufacturers through retail outlets. Tissue manufacture is a high speed, large volume operation. Typical commercial tissue machines may produce about 4 tons of tissue basesheet per hour, which is wound into large rolls (commonly referred to as parent rolls). The parent rolls are transferred to a converting operation where the parent rolls are unwound and the tissue basesheet is slit, folded, stacked and cut into clips (stacks of individual tissues, which may be interfolded). The tissue clips are then inserted into cartons, which are packed into cases and shipped to a distributor or retailer. Tissue manufacturing mills may produce about 16,000 cartons of facial tissue per hour. While tissue manufacturers try to offer consumers some variety in terms of packaging and the tissues within the package, the nature of the high speed manufacturing process and limited shelf space at retail outlets severely limits the ability of tissue manufacturers to provide consumers with more choices, given that any individual consumer's needs for facial tissue are limited.

Therefore there is a need for a method of providing consumers with customized facial tissue packages and/or tissues by which the consumer can select from various product options, such as package graphics, tissue graphics/color, scent, etc.

### SUMMARY OF THE INVENTION

It has now been discovered that customized facial tissues and/or associated packaging can be provided to select groups of consumers. While the customization options are not unlimited, targeting certain consumers by the method of this invention provides these consumers with a wide variety of choices which are still manageable from the standpoint of commercial manufacturing and converting processes.

More specifically, the invention resides in a method for a tissue manufacturer to provide customized facial tissue products for consumers comprising: (a) placing an advertisement for a customized facial tissue product in a topical medium, such as a magazine or website, said customized facial tissue product comprising tissues within a carton or other packaging, wherein the advertisement identifies a website that a reader of the topical medium can access for placing orders; (b) providing a website for placing orders from the reader, wherein the website offers the reader a choice of carton graphics, including color choices, that relate to the topic of the magazine and from which the reader can select and order; (c) selecting a customized carton graphics from the website and transmitting an order to a printer which prints the selected carton graphics on facial tissue cartons or other packaging; and (d) shipping a customized tissue product comprising a carton or other packaging containing the selected graphics directly to a destination chosen by the reader. The carton graphics suitably can be printed onto a carton blank prior to loading the tissue clip into the carton, or the carton graphics can be printed onto a film or label which is applied to the tissue product after loading or applied to the carton blank prior to loading. Unless otherwise stated, as used herein, any reference to printing graphics on the carton or carton blank includes printing graphics on films or labels that are applied to the carton.

As used herein, a “topical medium” is a publication, such as a magazine or brochure or article within a magazine or other advertising medium, or a website that is specifically focused on a specific topic or theme of interest to a certain targeted group of readers or customers. Examples of topical mediums particularly include, without limitation, magazines dedicated to topics such as weddings, parenting, baseball, basketball, football, golf, tennis, hockey, car racing, biking, birds, dogs, cats, fishing, hunting, bowling, decorating, flowers, landscaping, log homes, cooking and the like. It is important that the topical medium have a focused topic or theme in order to provide the reader with as many different customizable choices as is practical and which are related to the topic or theme. For example, if the topical medium is a fishing magazine, choices of related graphics could include a wide variety of fish species, lures and the like. If the topic is football, choices of related graphics could include team logos, helmets, a football, etc. If the topic is weddings, the related graphics could include figures of brides, grooms, flowers, diamonds, etc. In all cases, the related graphics or colors are things that the reader or customer would readily associate with the topic or theme of the medium.

Besides carton or packaging graphics and colors, other features of the tissue product can also be customized as well. In particular, a variety of scents may be offered, if desired, as well as a limited number of tissue basesheets, such as lotioned tissues, anti-viral tissues, and the like. Also, the consumer may be able to customize or personalize wording on the package, such as including the consumer's name or a personal message.

While cartons are the most likely type of packaging to be customized, other types of facial tissue packaging, such as canisters, cups and more flexible packages such as “pocket packs” and pouches, can also be customized. Cartons can be of various shapes such as cubic, rectangular, cylindrical, oval and the like. In addition, the cartons can include components or sub-assemblies, such as films, labels, lids and the like. Suitable materials include those commonly used for such containers, including cardboard and/or plastic. Unless otherwise stated, as used herein, “carton” includes any components or sub-assemblies associated with a particular carton design.

### DETAILED DESCRIPTION OF THE INVENTION

In practice, a tissue manufacturer would place an advertisement for the availability of customized facial tissue products in a topical medium, such as a magazine. The advertisement would identify a website which the reader of the magazine could access via computer in order to design and place an order for their customized facial tissue products.

The website would provide a variety of product choices as described above, particularly including packaging graphics choices relating to the topic of the magazine, which the consumer can select. Advantageously, the website could also provide other topical choices as well as the topic related to the particular magazine being read by the consumer. This would enable a consumer/reader having other interests to select from many different topical choices. Preferably the website would also have the capability to preview and display a picture or three-dimensional image of the tissue carton or package with the consumer's graphics choice(s) so the consumer can more readily visualize what the selected graphics will look like on the carton or package. As previously mentioned, the website can optionally offer choices for scents and tissue basesheet types, which may include lotions, virucides, softeners or embossing patterns. Another option may include print patterns for the tissue itself which also coordinate with the topic of the magazine.

Once the consumer has selected the customized product design, he/she places an order on the website for an amount of facial tissue product. As a practical matter, orders will likely have to exceed a certain minimum quantity, such as 24 cartons, for example. The order and the selected image can automatically be directed electronically to the tissue manufacturer or its designated vendor, which would likely be a company with a relatively small-scale, but flexible, converting capability that can handle small custom orders efficiently. In that situation, the tissue manufacturer could provide the vendor with a supply of parent rolls of tissue basesheet.

If the tissue basesheet is to be customized, the selected “generic” tissue basesheet would be unwound and passed through an optional printing station, most likely a digital printer. Digital printers have the capability to provide detailed images from electronic format and are particularly suited for slow speed/narrow width operations where there is time to clean any build-up of tissue dust/lint from the print heads. The basesheet may also be passed through a gravure printing station or a spray station to apply any desired lotion or scents. The tissue basesheet would then be folded and cut into appropriate clips for subsequent insertion into the selected packaging. If the tissue basesheet is not to be customized, it is simply passed to the folding and cutting operations.

If the tissue product involves a poly wrapper, the selected graphics can be printed on the poly wrapper using a digital printer and the printed wrapper is directed to the packaging operation.

If the tissue product involves a carton, a carton blank is printed with the selected graphics using a digital printer and the carton is directed to the packaging operation.

Once the assembly of the products is completed, the products are shipped directly to the consumer or to some other destination designated by the consumer. The specifics of the order can be maintained in a database by the tissue manufacturer so the consumer can re-order from time to time as desired or modify the existing design for future purchases.

It will be appreciated that the foregoing description, given for purposes of illustration, is not to be construed as limiting the scope of this invention, which is defined by the following claims and all equivalents thereto.

We claim:

1. A method for a tissue manufacturer to provide customized facial tissue products for consumers comprising:
(a) placing an advertisement for a customized facial tissue product in a topical medium, said customized facial tissue product comprising tissues within a carton or other packaging, wherein the advertisement identifies a website that a reader of the topical medium can access for placing orders;
(b) providing a website for placing orders from the reader, wherein the website offers the reader a choice of carton graphics, including color choices, that relate to the topic of the topical medium and from which the reader can select and order;
(c) selecting a customized carton graphics from the website and transmitting an order to a printer which prints the selected carton graphics on facial tissue cartons or other packaging; and
(d) shipping a customized tissue product comprising a carton or other packaging containing the selected graphics directly to a destination chosen by the reader.

2. The method of claim 1 wherein the facial tissue carton or other packaging is printed with the selected carton graphics prior to loading a tissue clip into the carton or other packaging.

3. The method of claim 1 wherein the facial tissue carton or other packaging is printed with the selected carton graphics after a tissue clip is loaded into the carton or other packaging.

4. The method of claim 1 wherein the selected carton graphics are printed at a converting facility of the tissue manufacturer.

5. The method of claim 1 wherein the selected carton graphics are printed at the facility of a vendor selected by the tissue manufacturer.

6. The method of claim 1 wherein the reader can preview an image of the customized tissue carton or package being ordered on the website.

7. The method of claim 1 wherein the shipping destination chosen by the reader is the reader's home address.

8. The method of claim 1 wherein the website further offers a choice of scents for scented tissues.

9. The method of claim 1 wherein the tissue product is a carton of tissues.

10. The method of claim 9 wherein the carton has a shape selected from the group consisting of rectangular, cubic, oval and cylindrical.

11. The method of claim 1 wherein the tissue product is pocket pack.

12. The method of claim 1 wherein the topical medium is an article within a magazine

13. The method of claim 1 wherein the topical medium is a brochure.

14. The method of claim 1 wherein the topical medium is a website.

15. A method for a tissue manufacturer to provide customized facial tissue products for consumers comprising:
(a) placing an advertisement for a customized facial tissue product in a topical magazine, said customized facial tissue product comprising tissues within a carton, wherein the advertisement identifies a website that a reader of the magazine can access for placing orders;
(b) providing a website for placing orders from the reader, wherein the website offers the reader a choice of carton graphics that relate to the topic of the magazine and from which the reader can select and order;
(c) selecting a customized carton graphics design from the website and transmitting an order to a printer;
(d) printing tissue cartons with the selected carton graphics design prior to assembling the carton and thereafter loading tissue clips into the cartons to produce a customized tissue product; and
(e) shipping the customized tissue product directly to the reader's home.
